(19) United States
(12) Patent Application Publication
(10) Pub. No.: US 2011/0123717 A1
(43) Pub. Date: May 26, 2011

(54) TWO PART SPRAY FOAM USING A BLOWING AGENT AS A PLASTICIZER AND A ROOM TEMPERATURE CROSSLINKING AGENT

(76) Inventor: Robert J. O'Leary, Newark, OH (US)

(21) Appl. No.: 12/875,640

(22) Filed: Sep. 3, 2010

Related U.S. Application Data
(63) Continuation-in-part of application No. 12/688,947, filed on Jan. 18, 2010.
Application No. 12/688,947 is a continuation-in-part of application No. 12/688,951, filed on Jan. 18, 2010.
Application No. 12/688,951 is a continuation-in-part of application No. 11/893,451, filed on Aug. 16, 2007.
Application No. 11/893,451 is a continuation-in-part of application No. 11/893,474, filed on Aug. 16, 2007.
Application No. 11/893,474 is a continuation-in-part of application No. 11/893,435, filed on Aug. 16, 2007.
Application No. 11/893,435 is a continuation-in-part of application No. 11/893,436, filed on Aug. 16, 2007.
Application No. 11/893,436 is a continuation-in-part of application No. 11/977,849, filed on Oct. 25, 2007.
Application No. 11/977,849 is a continuation-in-part of application No. 11/647,747, filed on Dec. 29, 2006.

(51) Int. Cl. C08J 9/06; B05D 1/02

(52) U.S. Cl. 427/426; 521/90; 521/88

(57) ABSTRACT

Latex spray foams formed from a non-aqueous two-part foamable composition are provided. The A-side contains includes a dry latex polymer, a multifunctional acid, and a liquid blowing agent and the B-side contains a polyfunctional aziridine crosslinking agent a plasticizer, and, optionally, a non-functionalized resin. The multifunctional acid may be a secondary emulsion that is added to the composition separately. The polyfunctional aziridine crosslinking agent may be diluted by a plasticizer, which reduces the viscosity of the B-side. The plasticizer should have no acidic protons to react with the crosslinking agent. When no acidic protons are present, the B-side is stable for extended periods of time. Additionally, the inventive foam and composition are desirably free of water. The lack of water or small amount of water in the inventive foam composition permits the foam to be sprayed at temperatures below freezing and to a greater thickness compared to water-containing compositions.

### CROSS-REFERENCE TO RELATED APPLICATIONS

This application is a continuation-in-part of U.S. patent application Ser. No. 12/688,947 entitled “Room Temperature Crosslinked Foam”, filed Jan. 18, 2010; a continuation-in-part of U.S. patent application Ser. No. 12/688,951 entitled “Formulation Method For Plural Component Latex Foam, filed Jan. 18, 2010; a continuation-in-part of each of U.S. patent application Ser. Nos. 11/893,451; 11/893,474; 11/893,435; and 11/893,436, each of which are entitled “Room Temperature Crosslinked Foam” and were filed on Aug. 16, 2007; and a continuation-in-part of U.S. patent application Ser. No. 11/977,849 entitled “Room Temperature Crosslinked Material”, filed on Oct. 25, 2007; and a continuation-in-part of U.S. patent application Ser. No. 11/647,747 entitled “Spray-In Latex Foam For Sealing And Insulating”, filed on Dec. 29, 2006, the entire contents of each are expressly incorporated herein by reference in their entireties.

### TECHNICAL FIELD AND INDUSTRIAL APPLICABILITY OF THE INVENTION

The present invention relates generally to spray foams and, more particularly, to user friendly foams that are used to fill cavities, cracks, and crevices to enhance the sealing and insulating properties of buildings, especially at low temperatures.

### BACKGROUND OF THE INVENTION

Spray foams have found widespread utility in the fields of insulation and structural reinforcement. For example, spray foams are commonly used to insulate or impart structural strength to items such as automobiles, hot tubs, refrigerators, boats, and building structures. In addition, spray foams are used in applications such as cushioning for furniture and bedding, padding for underlying carpets, acoustic materials, textile laminates, and energy absorbing materials. Spray foams are also used as insulators or sealants for home walls.

Both latex and polyurethane spray foams and their methods of manufacture are well known. Typically, polyurethane spray foams are formed from two separate components, commonly referred to as an “A” side and a “B” side, that react when they come into contact with each other. The first component, or the “A” side, contains an isocyanate such as a di- or poly-isocyanate that has a high percent of NCO (nitrogen, carbon and oxygen) functional groups on the molecule. The second component, or “B” side, contains nucleophilic reagents such as polyols that include two or more hydroxyl groups, silicone-based surfactants, blowing agents, catalysts, and/or other auxiliary agents. The nucleophilic reagents are generally polyols, primary and secondary polyamines, and/or water. Preferably, mixtures of diols and triols are used to achieve the desired foaming properties. The overall polyol hydroxyl number is designed to achieve a 1:1 ratio of first component to second component (A:B).

The two components are typically delivered through separate lines into a spray gun such as an impingement-type spray gun. The first and second components are pumped through small orifices at high pressure to form separate streams of the individual components. The streams of the first and second components intersect and mix with each other within the gun and begin to react. The heat of the reaction causes the temperature of the reactants in the first and second components to increase. This rise in temperature causes the blowing agent located in the second component (the “B” side) to vaporize and form a foam mixture. As the mixture leaves the gun, the mixture contacts a surface, sticks to it, and continues to react until the isocyanate groups have completely reacted. The resulting resistance to heat transfer, or R-value, may be from 3.5 to 8 per inch.

There are several problems associated with conventional latex and polyurethane spray foams. For instance, the processing of spray foams on site may be affected by inclement weather, which results in significant economic losses. One serious disadvantage of known spray foam systems is that they can only be used at ambient temperatures, typically above about 10° C. (50° F.). The effect of excessively low temperatures of the surface to be insulated is that too much heat of reaction is transferred from the first layer of the foamable polyurethane reaction mixture sprayed on the surface. This results not only in an increased gross density, but also embrittlement of the foam through incomplete reaction. The brittleness of the bottom surface of the foam is the main reason for loss of favorable adhesion properties to the substrate, which the foam system shows when processed on substrate materials which are at too low a temperature.

Another serious disadvantage, particularly with latex spray foams, is that the foams contain water. The presence of water in the foams results in several problems. First, at low temperatures, the water in the spray foams can freeze, thereby disrupting the quality of the foam itself. Second, the water causes the latex to be an open-celled foam of high density. Additionally, because the water takes time to go away, the foam cannot be sprayed to any great thickness. The weight of the water in the foam does not allow the foam to support itself. The foam, therefore, slides down a wall under its own weight. Furthermore, the acid base blowing agent means sodium is present in the final form, and sodium promotes hydrophilicity.

Additionally, conventional polyurethane spray foams contain high levels of isocyantes, such as methylene-diphenyl-di-isocyanate (MDI) monomers, in the first component (the “A” side). When the foam reactants are sprayed, the MDI monomers form droplets that may be inhaled by workers installing the foam if stringent safety precautions are not followed. Even a brief exposure to isocyanate monomers may cause difficulty in breathing, skin irritation, blistering and/or irritation to the nose, throat, and lungs. Extended exposure of these monomers can lead to a sensitization of the airways, which may result in an asthmatic-like reaction and possibly death.

An additional problem with such conventional polyurethane spray foams is that residual polymeric methylene-diphenyl-di-isocyanate (PMDI) that is not used is considered to be a hazardous waste. PMDI typically has an NCO of about 20%. In addition, PMDI can remain in a liquid state in the environment for years. Therefore, specific procedures must be followed to ensure that the PMDI waste product is properly and safely disposed of in a licensed land fill. Such precautions are both costly and time consuming.

In this regard, attempts have been made to reduce or eliminate the presence of isocyante in spray foams and/or reduce or eliminate isocyante emissions by spray foams into the atmosphere. Attempts have also been made to produce room temperature crosslinked foams. Some examples of such attempts are set forth below.

U.S. Patent Publication Nos. 2008/0161430; 2008/0161631; 2008/0161433; 2008/0161432; and 2009/0111902 to Korwin-Edson et al. a room temperature crosslinked foam, such as for filling cavities and crevasses. The foam contains an A-side that includes a functionalized latex and the B-side contains a crosslinking agent, and optionally, a non-reactive resin (e.g., a non-functionalized latex). Either or both the A-side or the B-side may contain a blowing agent package. Alternatively, the A-side and the B-side may each contain a component forming a blowing agent package. A plasticizer, a surfactant, a thickener, and/or a co-solvent may optionally be included in either the A- and/or B-side.

U.S. Patent Publication No. 2007/0290074 to Dansizen et al. teaches a method for the rapid insulation of expanses. The method utilizes a two-part spray foam system that may be applied at low temperatures; however, the chemicals must reach 70-85° F. for proper performance, and the system utilizes heated spraying hoses to heat the material for application at such low temperatures.

U.S. Pat. No. 5,444,099 to Abe et al., U.S. Pat. No. 4,945,120 to Kopp et al. and U.S. Pat. No. 3,984,360 to Galbreath et al. disclose a polyurethane spray foams capable of being applied at low temperatures. The polyurethane foams in each these patents require a polyisocyanate component.

U.S. Patent Publication No. 2006/0047010 to O'Leary teaches a spray polyurethane foam that is formed by reacting an isocyanate prepolymer composition with an isocyanate reactive composition that is encapsulated in a long-chain, inert polymer composition. The isocyanate prepolymer composition contains less than about 1 wt % free isocyanate monomers, a blowing agent, and a surfactant. The isocyanate reactive composition contains a polyol or a mixture of polyols that will react with the isocyanate groups and a catalyst. During application, the spray gun heats the polymer matrix, which releases the polyols and catalyst from the encapsulating material. The polyols subsequently react with the isocyanate prepolymer to form a polyurethane foam.

U.S. Pat. No. 7,053,131 to Ko, et al. discloses absorbent articles that include super critical fluid treated foams. In particular, super critical carbon dioxide is used to generate foams that assertedly have improved physical and interfacial properties.

Another option is a plastisol. A typical plastisol is an emulsion that uses plasticizer in the serum phase. The plasticizer is absorbed into the lattice to create a continuous plastic article. Plastisols, however, require heat to coagulate and form a film.

Despite these attempts, there remains a need in the art for a spray foam that is non-toxic and environmentally friendly and that may be applied at low temperatures.

### SUMMARY OF THE INVENTION

It is an object of the present invention to provide two-part spray foam compositions. In particular, the present invention is directed to a non-toxic and environmentally friendly, two-part spray foam that is capable of being applied at low temperatures.

It is yet another object of the present invention to provide a spray foam sealant and/or insulation for a building envelope that may be applied in cold temperatures, particularly at temperatures approaching about 20° F.

It is a further object of the present invention to provide a two-part emulsion spray foam that contains no water. The lack of water in the spray foam enables the spray foam to be applied at low temperatures without disrupting the quality of the foam.

The two-part spray foam composition of the present invention is formed of an A-side and a B-side. The A-side of the spray foam composition includes a dry latex and a blowing agent, and the B-side contains a crosslinking agent that crosslinks at room temperature and a plasticizer. Both the A-side and the B-side may contain additional ingredients typically found in spray foam compositions.

The spray foam of the present invention is a hybrid of latex spray foams and plastisols. Typically, a latex does not require heat to coagulate but does require that the colloid be destabilized and that the water drain away from the plastic. A plastisol requires that the material be heated to the point that the plasticizer is absorbed into the lattice. Plastisols generally require temperatures in excess of 200° F. to coagulate.

The foams of the present invention may be used to insulate buildings such as homes from temperature fluctuations outside of the building's envelope. The foams may serve both as a conductive and a convective thermal barrier. The foams of the present invention may also serve as a sealant or barrier to air infiltration by filling cracks and/or crevices in a building's roof or walls. Additionally, the foams may be used to form a barrier to seal cracks or crevasses around doors, windows, electric boxes, and the like.

The inventive foams do not release any harmful vapors into the air when applied or sprayed. As a result, the inventive foams reduce the threat of harm to individuals working with or located near the foam. In addition, the application of the foams is more amenable to the installer as he/she will not need to wear a special breathing apparatus during installation.

It is an advantage of the present invention that the inventive foams do not contain the harmful chemicals found in conventional polyurethane spray foams, such as, for example, isocyantes like MDI monomers. Therefore, the foams of the present invention do not contain harmful vapors that may cause skin or lung sensitization or generate toxic waste.

It is also an advantage that the inventive foams do not emit harmful vapors into the air when the foam is sprayed, such as when filling cavities to seal and/or insulate a building. The inventive foams are safe for workers to install and, therefore, can be used both in the house renovation market and in occupied houses. Additionally, because there are no harmful chemicals in the inventive foams, the foams can be safely disposed without having to follow any stringent hazardous waste disposal precautions.

It is a further advantage of the present invention that the foam could be dispensed in a pressurized aerosol form from a can or canister depending on the choice of blowing agent/propellant.

It is also an advantage of the present invention that the blowing agent can vaporize quickly and leave no liquid residue, unlike water, which has to diffuse slowly.

It is a further feature of the present invention that the foam may have a lower viscosity because there is no suspending of sodium bicarbonate on the B side.

It is yet another feature of the present invention that if a PVC lattice is used, then the foam of the present invention would be inherently flame retardant.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references. The terms “foamable composition” and “foam composition” may be interchangeably used in this application.

The present invention relates to a non-aqueous two-part spray foam that is suitable for use at low temperatures (e.g., temperatures below freezing). The inventive foams may be used to seal cracks and crevices of buildings, such as those around windows and doors, to improve sealing and insulation properties. In one exemplary embodiment, the inventive foam is formed from two components, namely, an A-side and a B-side. In particular, the A-side of the foam composition includes a dry latex polymer and a liquid blowing agent. Other components that may also be included in the A-side include a surfactant, a multifunctional acid, a crosslinker catalyst, and/or a nucleating agent. The B-side contains a polyfunctional aziridine crosslinking agent and a plasticizer, and optionally, optionally a surfactant, a filler, a nucleating agent, and a non-reactive resin.

In the inventive spray foam, a colloidal suspension is created with a blowing agent as the serum phase. When the suspension reaches a temperature above the boiling point of the blowing agent and atmospheric pressure, the blowing agent vaporizes, thereby allowing the emulsion to coagulate and form a film. At the same time, the vaporized serum phase creates bubbles to form a foam. Additionally, the suspension may contain a multifunctional acid that will react with a second crosslinking agent to create a “skeleton” to maintain the structure of the foam while the film is forming. In addition to the serum phase, the spray foam of the present invention includes a lattice phase. The lattice phase polymer may contain reactive groups that will bond to a second crosslinking component that is combined at the point of application.

In exemplary embodiment, the foams of the present invention, as well as the components thereof, meet certain performance properties, or Fitness for Use (“FFU”) criteria. In particular, the chemical property FFUs that the inventive foam should meet include the following criteria:
The foam should adhere to various materials such as wood, metal, concrete and plastic
The chemical constituents should be as safe as possible. If a hazardous chemical is used, it should not be introduced or atomized into the air where it can be inhaled
The foam may be chemically foamed through the use of a blowing agent or it may be mechanically foamed with a gas
The installer of the latex foam should be able to work with the material without any specialized personal protective equipment (“PPE”), such as a breathing apparatus, although chemical goggles, dust mask, and gloves are acceptable
The foam should not lend itself to molding or fungus growth (ASTM C1338)
The foam should not contain a food source for insects or rodents
There should be a minimum shelf life of the un-reacted constituents of 9 months.

It is also desirable that the inventive foams of the present invention meet certain physical property FFUs. The physical property FFUs that the inventive foam should meet include the following:
The foam weight should be between about 0.5 and about 30.0 pounds per cubic foot
The foam should be fluid enough to be sprayed either at room temperature or by heating (viscosity of <10,000 cP at a high shear rate)
The foam should not sag or fall in the cavity
The foam should fill in cracks and crevices or be used to coat the cavity with an air barrier
Ideally, the cell structure of the foam (closed vs. open) should be a mixture of both a closed and open cell structure to provide appropriate material properties to achieve the other FFUs
The foam should have a thermal resistance (R-value) of at least 3.0° F.ft²h/BTU per inch
The foam should be non-sagging and non-dripping (i.e., fire retardant) during a fire
The foam should not corrode metal objects such as screws, nails, electrical boxes, and the like
Air infiltration should be negligible (ASTM E283-04) (spec 0.4 cfm/sq ft)
Water vapor infiltration should be greater then 1 perm or 5.72×10⁻⁸ g/Pa-s-m²
The foam should have low or no odor.

As discussed above, the A-side of the composition for the foams according to the present invention includes a polymer lattice phase and a blowing agent as the serum phase. Any one of a number of polymers, particularly dry or solid (e.g., non-liquid) polymers, may be used as the lattice phase. In exemplary embodiments, the lattice phase is a dry latex polymer. Additionally, the polymer may be a functionalized polymer, such as a functionalized latex polymer. Non-limiting examples of suitable polymers for use in the inventive compositions include acetic acid ethenyl ester polymers; polyvinyl chloride (PVC); polyvinylidene chloride; acrylics; neoprene; styrene-butadiene rubber (SBR); nitrile rubbers (e.g., acrylonitrile-butadiene); polyisoprene rubbers; polychloroprene rubbers; polybutadiene rubbers; butyl rubbers; ethylene-propylene-diene monomer rubbers (EPDM); polypropylene-EPDM elastomers; ethylene-propylene rubbers; styrene-butadiene copolymers; styrene-isoprene copolymers; styrene-butadiene-styrene rubbers; styrene-isoprene-styrene rubbers; styrene-ethylene-butylene-styrene rubbers; styrene-ethylene-propylene-styrene rubbers; polyisobutylene rubbers; ethylene vinyl acetate rubbers; silicone rubbers including, for example, polysiloxanes; methacrylate rubbers; polyacrylate rubbers including, for example, copolymers of isooctyl acrylate and acrylic acid; polyesters; polyether esters; polyvinylidene chloride; polyvinyl ethers; polyurethanes; and combinations thereof. The polymer(s) forming the lattice phase may be present in an amount from about 40.0 to about 70.0 percent by weight of the A-side composition, and in exemplary embodiments, in an amount from about 50 to about 70 percent by weight, or from about 60 to about 70 percent be weight.

In addition to the polymer lattice phase, the A-side includes a liquid blowing agent as the serum phase. Suitable, non-limiting examples of blowing agents that may be used in the present invention include C₁ to C₉ aliphatic hydrocarbons (e.g., methane, ethane, propane, n-butane, cyclopentane, isobutane, n-pentane, isopentane, and neopentane), C₁ to C₃ aliphatic alcohols (e.g., methanol, ethanol, n-propanol, and isopropanol), HFC blowing agents (e.g., 1,1,1,3,3-pentafluoropropane (HFC-245fa), 1,1,1,4,4,4-hexafluorobutane (HFC-356mff), 1,1,1,3,3-pentafluorobutane (HFC-365mfc), 1,1,1,2-tetrafluoroethane (HFC-134a), 1,1-difluoroethane (HFC-152a), 1,1,1,3,3,3-hexafluoropropane (HFC-236fa), 1,1,1,3,3-pentafluorobutane (HFC-365mfc)); and nitrogen. It is to be appreciated that any of the blowing agents for use in the foamable composition can be used singly or in any combination thereof. Eliminating an acid/base blowing agent system also eliminates the need for sodium to be present in the final foam. Sodium can be detrimental to the foam as it is hydrophilic in nature. The blowing agent may be present in an amount from about 25.0 to about 50.0 percent by weight of the A-side composition, and in exemplary embodiments, in an amount from about 30.0 to about 40.0 percent by weight.

The A-side of the inventive foam composition may also include at least one multifunctional acid. The multifunctional acid reacts with the polyfunctional aziridine crosslinking agent found in the B-side to create a “skeleton” to maintain the structure of the foam while the foam is forming. Additionally, the acid is placed in the A-side to avoid the inclusion of the acidic protons in the acid in the B-side and an undesirable pre-reaction of the polyfunctional aziridine crosslinking agent. In exemplary embodiments, the acid is a dry acid powder without chemically bound water. Non-exclusive examples of multifunctional acids include, but are not limited to, polyacrylic acid, citric acid, oxalic acid, tartaric acid, succinic acid, fumaric acid, adipic acid, maleic acid, malonic acid, glutaric acid, phthalic acid, metaphosphoric acid, or salts that are convertible into an acid that is an alkali metal salt of citric acid, tartaric acid, succinic acid, fumaric acid, adipic acid, maleic acid, oxalic acid, malonic acid, glutaric acid, phthalic acid, metaphosphoric acid, or a mixture thereof. Examples of salts which are convertible into acids include, but are not limited to, aluminum sulfate, calcium phosphate, alum, a double salt of an alum, potassium aluminum sulfate, sodium dihydrogen phosphate, potassium citrate, sodium maleate, potassium tartrate, sodium fumarate, sulfonates, and phosphates. In exemplary embodiments, the acid is a polyacrylic acid. The multifunctional acid may be present in an amount from about 2.0 to about 10.0 percent by weight of the dry foam composition, and in exemplary embodiments, in an amount from about 4.0 to about 6.0 percent by weight.

In an alternative embodiment, the multifunctional acid may be a secondary emulsion that is added to the composition separately. For example, if the multifunctional acid is not miscible in the blowing agent, then the acid may be introduced into the foamable composition as a stable emulsion within the serum phase. The multifunctional acid may be placed into an emulsion with the assistance of a surfactant, such as the surfactants described herein.

Also, the A-side may contain one or more surfactants to impart stability to during the foaming process and to provide a high surface activity for the nucleation and stabilization of the foam cells. In exemplary embodiments, the surfactant is one that isolates the polymer lattice from the serum phase. Useful surfactants include cationic, anionic, amphoteric and nonionic surfactants such as, for example, carboxylate soaps such as oleates, ricinoleates, castor oil soaps and rosinates, quaternary ammonium soaps and betaines, amines and proteins, as well as alkyl sulphates, polyether sulphonate (e.g., Triton X200K available from Cognis), octylphenol ethoxylate (e.g., Triton X705 available from Cognis), disodium N-octadecyl sulfosuccinamate (e.g., Aerosol 18P available from Cytec), octylphenol polyethoxylates (e.g., Triton X110 available from Cognis), alpha olefin sulfonate, sodium lauryl sulfates (e.g., Stanfax 234 and Stanfax 234LCP from Para-Chemicals), ammonium laureth sulfates (e.g., Stanfax 1012 and Stanfax 969(3) from Para-Chemicals), ammonium lauryl ether sulfates (e.g., Stanfax 1045(2) from Para-Chemicals), sodium laureth sulfates (e.g., Stanfax 1022(2) and Stanfax (1023(3) from Para-Chemicals), sodium sulfosuccinimate (e.g., Stanfax 318 from Para-Chemicals), and aliphatic ethoxylate nonionic surfactants (e.g., ABEX available from Rhodia). The surfactant may be present in the A-side in an amount from about 0.5 to about 2.0 percent by weight of the A-side composition, and in exemplary embodiments, in an amount from about 0.5 to about 1.0 percent by weight.

As mentioned previously, the B-side of the composition contains a polyfunctional aziridine crosslinking agent, and a plasticizer, and optionally a surfactant, a filler, a nucleating agent, and a non-reactive resin. In particular, the non-reactive resin is a resin that does not react with the polyfunctional aziridine crosslinking agent, but is otherwise non-limiting. Examples of suitable polyfunctional amines include XAMA®-7 and XAMA®-2, tri-functional aziridines available from Bayer Corporation; PZ-33, an ethylene imine-based tri-functional polyaziridine available from PolyAziridine, LLC; Crosslinker CX-100, a polyfunctional aziridine available from DSM NeoResins; and XC-103, a trifunctional aziridine available from Zealchem. The polyfunctional aziridine crosslinking agent may be present in the B-side in an amount from about 10.0 to about 25.0 percent by weight of the dry foam composition, preferably in an amount from about 15.0 to about 18.0 percent by weight. Although a mole ratio of the resin functional groups to the polyfunctional aziridine crosslinking agent functional groups of 1:1 is preferred, this molar ratio is variable and may encompass a wider range, such as, for example, from 0.5:1 to 2:1 to provide the optimum crosslinking in the final foam products.

According to one aspect of the invention, the crosslinking agent is diluted by a plasticizer. The plasticizer should have no acidic protons to react with the aziridine groups in the crosslinking agent. Examples of suitable plasticizers for use in the B-side of the foamable composition include butyl benzoate, Benzoflex® 2088 (a benzoate ester plasticizer available from Genovique Specialties), Benzoflex® LA-705 (a benzoate ester plasticizer available from Genovique Specialties), Citroflex® 2 (a triethyl citrate available from Vertellus® Specialties), and Citroflex° 4 (a tributyl citrate available from Vertellus® Specialties). In exemplary embodiments, the plasticizer is a benzoate ester or a citric acid ester.

Diluting the polyfunctional aziridine crosslinking agent provides several advantages. For example, the toxic components of the polyfunctional aziridine can be diluted in the benzoate ester to reduce health risks to those in contact with the polyfunctional aziridine. Polyfunctional aziridine contains about 0.001% of ethyleneimine, which is a very reactive moiety, and in theory, will react with the very small level of acid impurities or water content of the other components the B-side. In addition, the viscosity of the B-side is reduced when the crosslinking agent is diluted with the plasticizer. As a result, the components of the B-side can be better mixed with the latex of the A-side in the spray gun to form a homogeneous mixture. Additionally, the plasticizer reduces the amount of ethyleneimine, a toxic component in the polyfunctional aziridine crosslinking agent. Also, the plasticizer allows the foam composition to be delivered with standard plural component spray equipment, thereby negating the need for any specialized equipment.

Additionally, the presence of the plasticizer permits for the inclusion of other solid materials that may add functionality and/or cost savings to the final foamed product. For instance, coacervating agents, fillers (e.g., calcium carbonate and wollastonite fibers), nucleating agents (e.g., talc), and/or foaming agents (e.g., sodium bicarbonate) can be included in the B-side of the foamable composition. The inclusion of fillers such as wollastonite fibers helps with the stability of the cell structure after the cells have been formed. It is to be appreciated that when the plasticizer and other components in the B-side do not contain any acidic protons, the B-side is stable for extended periods of time, such as up to at least six months or more.

In addition to the components set forth above, either or both the A-side and B-side may also include a nucleating agent. Suitable, non-limiting examples of nucleating agents that may be used in the spray foam of the present invention are talc, precipitated calcium carbonate, and silica. The nucleating agent may be present in an amount from about 1.0 to about 10.0 percent by weight of the dry foam composition, and in exemplary embodiments, in an amount from about 1.0 to about 5.0 percent by weight.

In the spray foam of the present invention, the A- or B-side may also include other optional, additional components such as, for example, foam promoters, opacifiers, accelerators, foam stabilizers, dyes (e.g., diazo or benzimidazolone family of organic dyes), color indicators, gelling agents, flame retardants, biocides, fungicides, algaecides, fillers (aluminum tri-hydroxide (ATH)), and/or conventional blowing agents. It is to be appreciated that a material will often serve more than one of the aforementioned functions, as may be evident to one skilled in the art, even though the material may be primarily discussed only under one functional heading herein. The additives are desirably chosen and used in a way such that the additives do not interfere with the mixing of the ingredients, the cure of the reactive mixture, the foaming of the composition, or the final properties of the foam.

It is to be appreciated that the inventive foam and composition are desirably free of water. However, small amounts (e.g., 2-3%) of water may be brought into the system, such as though added components, as is discussed in detail below. However, the water is in such a small amount that it does not disrupt the foam process or create other problems heretofore associated with the inclusion or presence of water in foamable compositions. The water-free or substantially water-free latex foam composition as recited herein enables the foam to be sprayed to a greater thickness than water-containing foams. For instance, in conventional latex foams, the weight of the water prevents the foam from being able to support itself. Thus, the foam, after being sprayed, will slide down a vertical surface under its own weight. Also, the lack of water in the inventive foams permits the foam to be closed celled with a relatively low density. In some exemplary embodiments, the density of the foam may be between about 0.5 and about 20 pounds per cubic foot, or from about 15 to about 18 pounds per cubic foot. In addition, the water present in conventional latex foams can freeze, thereby destroying the structural integrity of the foam. Further, the lack of water in the inventive foam composition permits the foam to be sprayed at low temperatures, including below-freezing temperatures.

To form a two-part spray foam of the present invention, the components of the A-side and the components of the B-side are delivered through separate lines into a spray gun, such as an impingement-type spray gun. The gun is heated to a temperature above the boiling point of the blowing agent. It is to be appreciated that the heat being supplied to the mixture may be derived from sources such as built-in heaters, a heated hose, or a heated gun. The two components are pumped through small orifices at high pressure to form streams of the individual components of the A-side and the B-side. The streams of the first and second components intersect and mix with each other and heat up within the gun. Because the components are under pressure inside the gun, the blowing agent does not vaporize. However, as the mixture exits the gun and enters into atmospheric pressure, the blowing agent vaporizes. As the blowing agent vaporizes, the lattice particles come closer together until a point at which they coagulate. The very action of the serum phase turning to vapor forces the lattice particles together.

While the blowing agent is vaporizing, the polyfunctional aziridine crosslinking agent is reacting with the multifunctional acid and lattice polymer to form a supporting structure. The polyfunctional aziridine also reacts with the functional groups positioned on the lattice polymer, if functional groups are present. The reaction of the polyfunctional aziridine with the acid and the lattice polymer forms a polymeric scaffolding-like structure (skeleton or lattice) that holds the foam structure while the lattice polymer is coagulating and hardening. The previously fluid/viscous foam material is substantially immobilized by the internal scaffolding-structure, which prevents the foam from collapsing. It is hypothesized that the use of a multifunctional acid advantageously provides for a more flexible backbone in the polymeric structure. It is to be appreciated that the amount of functionality in the polyfunctional aziridine crosslinking agent, the lattice polymer, and the acid are adjusted to result in optimum crosslinking.

It is to be appreciated that the crosslinking is important for capturing the bubbles generated by the evolution of the gas in their original, fine structure before they can coalesce and escape the foam. A fine foam structure is more desirable and more beneficial than a coarse foam structure in order to achieve a high structural, thermal, and air sealing performance. Additionally, the crosslinking of the functional groups on the dry latex quickly builds strength in the foam and permits the foam to withstand the force of gravity when it is placed, for example, in a vertical wall cavity during application. The final foamed product becomes cured to the touch within minutes after application. The foamed product has an integral skin that restricts the passage of air but permits the passage of water vapor. In exemplary foamed products, the foam hardens within about 1 to 6 minutes. The resulting resistance to heat transfer, or R-value, may be from about 3.5 to about 8 per inch.

In use, the inventive foams may be sprayed into a closed cavity where it expands to seal any open spaces. In another embodiment, the foams of the present invention may be used to seal the insulative cavities of a building such as a house and minimize or eliminate air flow into the insulative cavities and effectively seal the building. The foams of the present invention may also be used to insulate buildings such as homes from temperature fluctuations outside of the building's envelope. Additionally, the foams of the present invention may serve as a sealant to air infiltration by filling cracks and/or crevices in a building's roof or walls, around doors, windows, electric boxes, and the like. The foam may also be applied to seal holes in walls and floors. The foams may serve both as a conductive and a convective thermal barrier. In exemplary embodiments, the application of the foam is a continuous spray process.

The inventive foam can also be used in applications where extruded polystyrene foam forms the envelope of a building. Although polystyrene foams are good insulators, they have a tendency to buckle and create gaps and/or crevices. Similarly, when a fibrous board is used as the sheathing, gaps and crevices naturally occur, such as at the interfaces between the sheathing and framing due to the natural warping and curvature of fibrous products. The inventive foams may be sprayed into these crevices and gaps as a sealant to reduce or eliminate air infiltration into the insulative cavity.

Additionally, the inventive latex foams may be applied to the faces of the studs (or the face of the framing of the building) to obtain a superior seal against air infiltration. In particular, the inventive foam is sprayed or otherwise applied to the face of the studs as described above and drywall is attached to the surface of the studs in a conventional manner. Desirably, the foam is sprayed onto the stud faces prior to the insertion of the insulation into the building cavities. It is to be understood that the foam may be sprayed to the faces of the studs with or without applying the foam around the interior boundary of the insulative cavities. The elastomeric foam acts as a gasket seal between the stud face and the drywall. In addition, the foam assists in leveling and smoothing the stud surface to which the drywall will be attached.

The spray foam composition of the present invention has several benefits. One important benefit of the inventive foam composition is that the foam may be applied in cold conditions, including temperatures approaching about 20° F., without adversely affecting the nature of the foam. Moreover, the spray foam of the present invention contains no water or, if water is present (such as, for example, in an additive), the water is present in only a small amount. The lack of water (or small amount of water) in the spray foam means that water not is present in the foam in an amount such that it would freeze at low temperature and disrupt the quality of the foam. A further benefit resulting from the lack of water in the spray foam of the present invention is that the blowing agent can vaporize quickly and leave no residue, like water, which diffuses very slowly over time.

Another advantage of the foams of the present invention is the safe installation of the foam into cavities. Because the foams do not release any harmful vapors into the air when applied or sprayed, the inventive foams reduce the threat of harm to individuals working with or located near the foam. In addition, the application of the foams is more amenable to the installer as he/she will not need to wear a special breathing apparatus during installation.

Another advantage of the inventive foams is that it can be used in the renovation market, as well as in houses that are occupied by persons and/or animals (e.g. renovation market). Existing, conventional spray polyurethane foams cannot be used in these applications because of the generation of high amounts of free isocyanate monomers that could adversely affect the occupants of the dwelling. As discussed above, exposure of isocyanate monomers may cause irritation to the nose, throat, and lungs, difficulty in breathing, skin irritation and/or blistering, and a sensitization of the airways.

It is also an advantage of the spray foam that, unlike conventional spray polyurethane foams, the foams of the present invention do not contain isocyanate. Therefore, no MDI monomers are present in the inventive foams. Because the inventive foam does not contain isocyanate, no harmful chemicals are emitted during installation of the foams.

Having generally described this invention, a further understanding can be obtained by reference to certain specific examples illustrated below which are provided for purposes of illustration only and are not intended to be all inclusive or limiting unless otherwise specified.

### Example

Table 1 sets forth a list of proposed components that may be used to make at least one exemplary embodiment of the inventive foam.

TABLE 1
Proposed Components

| | | Sample A | Sample B | Sample C |
|---|---|---|---|---|
| | | % by | % by | % by |
| | Manufacturer | weight | weight | weight |
| SIDE A | | | | |
| Dry Latex Polymer | | | | |
| DLP-2141 | Dow Chemical | 60 | | |
| DLP-2001 | Dow Chemical | | 60 | |
| DLP-211 | Dow Chemical | | | 60 |
| Surfactant | | | | |
| Triton X100 | Cognis | | 1 | |
| Stanfax 234 | Para- | 1 | | |
| | Chemicals | | | |
| Ammonium | — | | | 1 |
| Succinate | | | | |
| Blowing Agent | | | | |
| HFC-245(fa) | Honeywell | 34 | | |
| Cyclopentane | — | | 17 | 34 |
| Isobutane | — | | 17 | |
| Multifunctional | | | | |
| Acid | | | | |
| Aquaset 1676 | Dow Chemical | 5 | | 5 |
| Jaypol | Omnova | | 5 | |
| SIDE B | | | | |
| Benzoflex ® 2088 | Genovique | 72 | | |
| | Specialties | | | |
| Citroflex ® 4 | Vertellus ® | | 71 | |
| | Specialties | | | |
| Citroflex ® 2 | Vertellus ® | | | 72 |
| | Specialties | | | |
| Crosslinking Agent | | | | |
| PZ-33 | PolyAziridine, | 17 | | 17 |
| | PLLC | | | |
| XAMA ® 7 | Bayer | | 18 | |
| | Chemical | | | |
| Thickening Agent | | | | |
| Thixatrol Max ® | Elementis | 1 | 1 | 1 |
| | Specialties | | | |
| Vansil ® HR 1500 | RT Vanderbilt | 10 | 10 | 10 |
| (wollastonite fiber) | Co, Inc. | | | |

The A-side and the B-side would be mixed at a ratio of about 4:1 (A:B).

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A two-part non-aqueous foamable composition for forming a foam comprising:
a first component including:
a lattice phase formed of at least one dry polymer;
a liquid blowing agent;
a multifunctional acid; and
a surfactant; and
a second component including:
a polyfunctional aziridine crosslinking agent that crosslinks at or about room temperature; and
a plasticizer,
wherein said plasticizer has no acidic protons to react with said polyfunctional aziridine crosslinking agent.

2. The two-part non-aqueous foamable composition of claim 1, wherein said first and second components are substantially free of water.

3. The two-part non-aqueous foamable composition of claim 1, wherein said polymer is a dry latex polymer.

4. The two-part non-aqueous foamable composition of claim 1, wherein said plasticizer is selected from a benzoate ester, triethyl citrate, a tributyl citrate, polyethylene glycol, an octylphenoxypolyethoxyethanol, butyl benzoate and combinations thereof.

5. The two-part non-aqueous foamable composition of claim 2, wherein said plasticizer reduces the viscosity of the second component such that said second component can be mixed with said first component to form an homogenous mixture

6. The two-part non-aqueous foamable composition of claim 1, wherein said multifunctional acid is in the form of a secondary emulsion added separately to said first component.

7. The two-part non-aqueous foamable composition of claim 1, wherein said second component further comprises at least one member selected from a surfactant, a filler, a nucleating agent and a non-reactive resin, said non-functionalized resin being non-reactive with said polyfunctional aziridine crosslinking agent.

8. The two-part non-aqueous foamable composition of claim 1, wherein said multifunctional acid is a dry acid powder without chemically bound water.

9. A foamed product comprising the reaction product of:
a first component including:
a lattice phase formed of at least one dry polymer;
a liquid blowing agent;
a multifunctional acid; and
a surfactant; and
a second component including:
a polyfunctional aziridine crosslinking agent that crosslinks at or about room temperature; and
a plasticizer,
wherein said plasticizer has no acidic protons to react with said polyfunctional aziridine crosslinking agent.

10. The foamed product of claim 9, wherein said polymer is a dry latex polymer.

11. The foamed product of claim 10, wherein said plasticizer is selected from a benzoate ester, triethyl citrate, a tributyl citrate, polyethylene glycol, an octylphenoxypolyethoxyethanol, butyl benzoate and combinations thereof.

12. The foamed product of claim 11, wherein said multifunctional acid is a dry acid powder without chemically bound water.

13. The foamed product of claim 10, wherein said first and second components are substantially free of water.

14. The foamed product of claim 10, wherein said second component further comprises a non-functionalized resin, said non-functionalized resin being non-reactive with said polyfunctional aziridine crosslinking agent.

15. A method of forming a foam barrier comprising:
delivering a first component including at least one dry polymer, a liquid blowing agent, a multifunctional acid, and a surfactant through a first delivery line to an application device;
delivering a second component including a polyfunctional aziridine crosslinking agent that crosslinks at or about room temperature and a plasticizer to said application device, said plasticizer having no acidic protons to react with said polyfunctional aziridine crosslinking agent;
mixing said first and second components within said application device to form a reaction mixture;
permitting said polyfunctional aziridine crosslinking agent, said acid, and said one or more functionalized resins to chemically react while said blowing agent forms a gas to initiate a foaming reaction and form a sealing and/or insulative foam; and
spraying said foam to a desired location, said desired location being selected from an open cavity, a closed cavity, a crevasse and a crack.

16. The method of claim 15, further comprising:
heating said reaction mixture to a temperature above the boiling point of said blowing agent to vaporize said blowing agent.

17. The method of claim 15, wherein said first and second components are substantially free of water.

18. The method of claim 15, wherein said second component further comprises at least one member selected from a surfactant, a filler, a nucleating agent and a non-reactive resin, said non-functionalized resin being non-reactive with said polyfunctional aziridine crosslinking agent.

19. The method of claim 15, wherein said multifunctional acid is a dry acid powder without chemically bound water.

20. The method of claim 15, wherein said foam is sprayed at a temperature below freezing.
